(19) United States
(12) Patent Application Publication
(10) Pub. No.: US 2020/0253405 A1
(43) Pub. Date: Aug. 13, 2020

(54) DEVICE FOR SECURING A CONTAINER TO A PLANAR SURFACE

(71) Applicant: Ramon Eduardo Da Silva Romero, Austin, TX (US)

(72) Inventor: Ramon Eduardo Da Silva Romero, Austin, TX (US)

(21) Appl. No.: 16/782,732

(22) Filed: Feb. 5, 2020

Related U.S. Application Data
(60) Provisional application No. 62/803,447, filed on Feb. 9, 2019.

(51) Int. Cl. A47G 23/02; F16M 13/02

(52) U.S. Cl. CPC A47G 23/0225; F16M 13/022

(57) ABSTRACT

A device for securing a container to a planar surface so that that the container does not fall off the planar surface is disclosed. The device includes a clamping element configured to removably attach the device to the side of the planar surface. At least one retaining element is connected to the clamping element and positioned on top of an upward-facing surface of the planar surface. At least one retaining element is configured to move between a gripping configuration and a non-gripping configuration. In the gripping configuration, each retaining element holds a container on top of the planar surface when the device is attached to the side of the planar surface.

### CROSS-REFERENCE TO RELATED APPLICATIONS

This application claims the benefit of the filing date of U.S. Provisional Application Ser. No. 62/803,447 titled “DEVICE FOR SECURING A CONTAINER TO A PLANAR SURFACE” and filed Month Feb. 9, 2019, and the subject matter of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present invention relates to the field of hotel and restaurant beverage supplies, and more specifically, to the field of container securement devices.

### BACKGROUND

Room service is an important, distinguishing characteristic and a necessary service for upscale hotels, resorts, and cruise ships. Also referred to as “in-room dining,” room service is defined as an operating department within a lodging facility that takes guest orders for food, prepares that food, and delivers it to the guest's room for consumption there. However, many challenges make it difficult for facilities to efficiently and adequately deliver food and beverage to guest rooms. For example, delivery of food and beverage to a guest room is generally more labor-intensive than restaurant services, if for no other reason than less distance needs to be covered to successfully deliver meals in a restaurant, as opposed to taking that meal to a hotel guest room which may be quite distant from the kitchen where it was prepared.

Another challenge is the mitigation or elimination of delays caused by sliding, tipping, and accidental beverage spills during room service delivery. In the hospitality industry, when carrying beverages on a cart, tray or cart, employees must be conscientious when maneuvering the table, tray or cart so that the table, tray or cart does not bump into other items, such as a wall because that will most likely result in the glass to fall, break, and spill the whole beverage. Although the problem of why liquid spills might seem trivial, it actually brings together a variety of fundamental scientific issues. These include fluid mechanics, the stability of fluid surfaces, and interactions between fluids and structures. When a rigid container is accelerated horizontally, the low viscosity fluid remains at rest and is left behind to rise up on the container's wall. The greater the acceleration is compared to gravity, the more fluid is left behind. Later, when the person stops moving forward, the container is decelerated, but the fluid in motion remains in motion toward the other end of the container. In some cases, there is an amplifying resonance when the accelerations match the natural frequency of the fluid's back and forth sloshing. Such effects can be observed when a glass of water is handled carelessly, and the fluid sloshes or even spills over the rims of the container.

Beyond the guest perception of the delivered product, the problem of liquid spills in moving containers remains of great concern in the hospitality industry. Currently, there appears to be no agreement on the best principles and practices to utilize in the mitigation or elimination of delays caused by accidental beverage spills during room service delivery. As a result, there exists a need for improvements over the prior art and, more particularly, for a better device to secure a container to a planar surface so that that the container does not fall off the planar surface.

### SUMMARY

An apparatus and method for securing a container to a planar surface is disclosed. This Summary is provided to introduce a selection of disclosed concepts in a simplified form that are further described below in the Detailed Description, including the drawings provided. This Summary is not intended to identify key features or essential features of the claimed subject matter. Nor is this Summary intended to be used to limit the claimed subject matter's scope.

In one embodiment, an apparatus for securing a container to an item is disclosed. The apparatus comprises a clamping or attaching element configured to removably attach the apparatus to the object. The apparatus also includes at least one retaining element connected to the clamping element and configured to be positioned on top of an upward-facing surface of the object. The retaining element is configured to move between a gripping configuration and a non-gripping configuration. In the gripping configuration, each retaining element holds the container on the object when the apparatus is attached to the upward-facing side of the object.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a perspective view of a device for securing an item to a planar surface, according to an example embodiment of the present invention;

FIG. 2 is a top perspective view of the device for securing an item a planar surface in a fully closed configuration, according to an example embodiment of the present invention;

FIG. 3 is a top perspective view of the device for securing an item to a planar surface where one of the retaining elements is an open configuration, and one of the retaining elements is in a fully closed configuration, according to an example embodiment of the present invention;

FIG. 4 is a top perspective view of the device for securing an item to a planar surface attached to the side of a table in a gripping configuration and where the retaining elements are holding items, according to an example embodiment of the present invention;

FIG. 5 is a top perspective view of the device for securing an item to a planar surface in a closed configuration with a cover securing the biasing element, according to an example embodiment of the present invention; and,

FIG. 6 is a block diagram depicting an exemplary method for securing a container o a planar surface, according to an example embodiment of the present invention.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a device for securing an item or container to a planar surface so that that the container does not fall off the planar surface. The present embodiment improves over the prior art by providing an attaching element, such as a clamping element, configured to removably attach the device to the side of a planar surface. Moreover, a plate attached to the clamping end of the lower part allows the clamping element to clamp onto a greater number of planar surfaces. Additionally, the disclosed embodiments improve over the prior art by providing at least one retaining element connected to the clamping element and positioned on top of an upward-facing surface of the planar surface that is configured to move between a gripping configuration and a non-gripping configuration. In the gripping configuration, each retaining element holds a container on the upward-facing side of the planar surface when the device is attached to the side of the planar surface, The retaining element allows for a variety of glassware and other applicable items to be held in place during transport to prevent sliding and accidental spills.

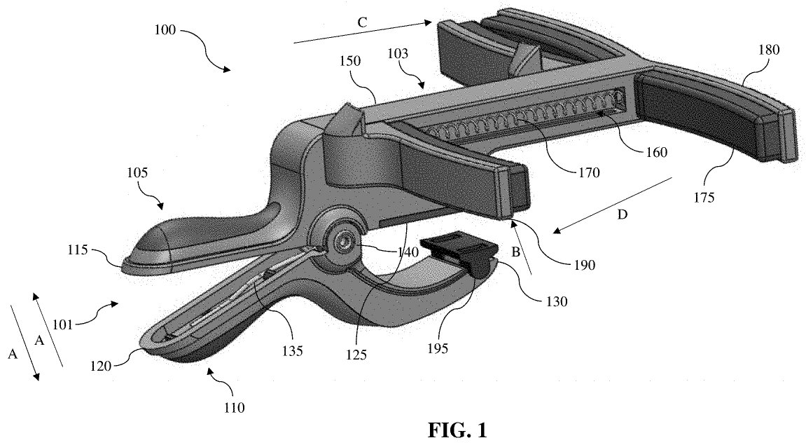

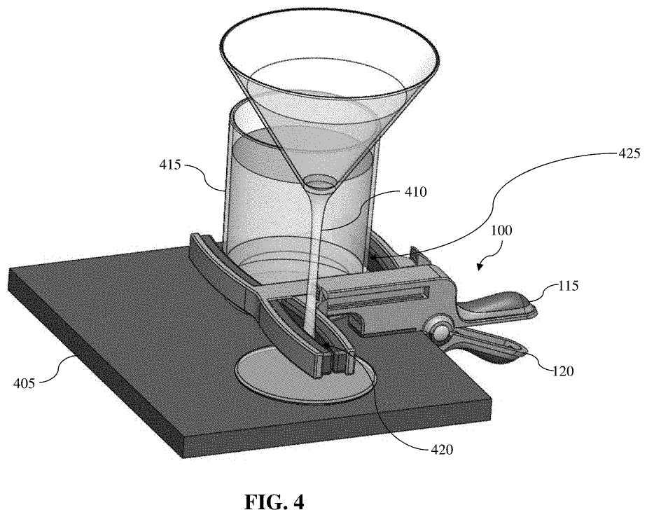

Referring now to the Figures, FIG. 1 is a perspective view of an apparatus 100 for securing a container to a planar surface so that the container does not fall off the planar surface according to an example embodiment of the present invention. The apparatus comprises an attaching element 101 (also known as the clamping element) configured to removably attach the device to the side of a planar surface, as shown in FIG. 4.

The attaching element 101 may be manifested via a clamping structure, clasping structure, compressing structure, gripping structure, magnetic attaching structure, or any other applicable means of removably attaching the apparatus to a planar surface or other applicable objects. In one embodiment, the object may be a tray, table, or other object having a planar or flat upward-facing surface or any other object that may have items placed on top of the surface of the object. However, it is understood that other types of objects may be used that are within the spirit and scope of the present invention.

In the present embodiment, the aching element 101 (also known as the clamping element) comprises an upper part 105 having a handle end 115 and a passive attaching portion 125 or upper clamping portion, and a lower part 110 having a handle end 120 and a lower clamping portion 130. The components of the attaching element may be comprised of materials such as galvanized steel or iron, copper, polybutylene, unplasticized polyvinylchloride (PVC), chlorinated polyvinylchloride (CPVC) and polyethylene (PE) to increase corrosion resistance to specific environments, enhance oxidation resistance, and impart special characteristics.

In one embodiment, the attaching element 101 is configured to allow a user to affix the attaching element 101 to a side or end of a planar surface via the user applying a squeezing force (as illustrated by lines A) onto handle portions 115, 120 such that the clamping portions 125, 130 substantially move away (opposite from the direction of line B) from each other, then releasing the squeezing force so that the clamping portions move toward each other because of a biasing force (in the direction of arrowed line B) provided by a biasing force of a biasing element (further explained below).

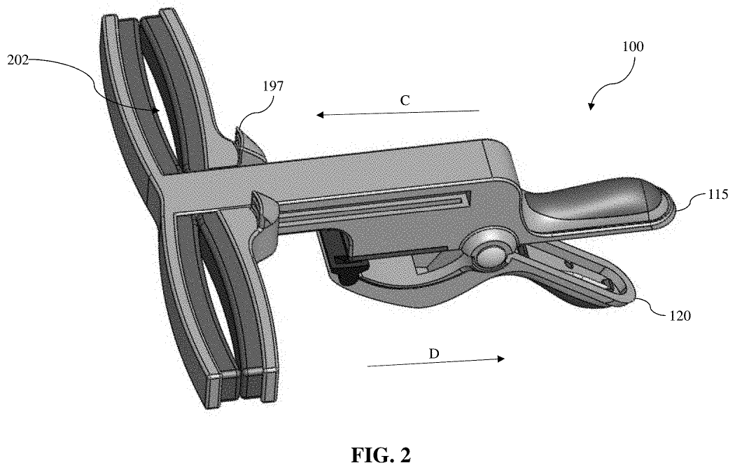

The biasing force generates a clamping, clasping, or gripping force that securely retains placement of apparatus 100 on the planar surface. Stated differently, the biasing element provides a biasing force for continually biasing the upper clamping portion and lower clamping portion toward each other toward a fully closed position (closed position illustrated in FIG. 2). In the case where there is no planar surface to attach to, clamping portion 125 and lower clamping portion 130 may be in direct contact with each other once the downward and upward forces are applied. In one embodiment, handle ends 115 and 120 may include one or more gripping surfaces made of rubber, polymeric materials, or any other applicable materials, and is configured to integrate and come in contact with the hand of a user. For example, lower part 110 may include one or more grooves configured to support the placement of the user's fingers on handle end 120 while upper part 105 includes a surface configured for a palm of the user's hand apportioned on handle end 115.

In one embodiment, attaching element 101 further comprises a torsion spring 135 or biasing element rotatably engaging upper part 105 with the lower part 110, and a hinging mechanism 140 (or pin configured to allow the upper part and lower part configured to rotate relative to each other) to support pivoting of lower part 110 in cooperation with torsion spring 135. In one embodiment, torsion spring 135 or biasing may generate a biasing force (as illustrated by line B) for continually biasing upper part 105, and lower part 110 toward each other in an attempt to achieve a closed or substantially dosed position wherein upper part 105 and lower part 110 are in direct physical contact. Hinging mechanism 140 may be a screw, magnet, or any other applicable mechanical bearing configured to connect two solid items and allow a limited angle of rotation between them. In one embodiment, upper part 105, handle end 115, and clamping end 125 are stationary while lower part 110, handle end 120, and clamping end 130 may support a range of movements provided by pivotal rotating respective to hinging mechanism 140 and the interaction with torsion spring 135. In the present embodiment, apparatus 100 has a horizontal alignment configured to establish retention of an item according to the orientation of the planar surface (extending horizontally along the planar surface). However, it should be appreciated that apparatus 100 can have other shapes, dimensions, and orientations that allow apparatus 100 to retain items efficiently, and such variations are within the spirit and scope of the claimed invention. In one embodiment, lower clamping portion 130 comprises a plate 195 configured to allow attaching element 101 to be affixed onto a greater number of planar surfaces than without the plate. In the present embodiment, plate 195 has a generally planar rectangular-shaped body. However, it should be appreciated that plate 195 can have other shapes and dimensions, and such variations are within the spirit and scope of the claimed invention. Plate 195 is secured to the attaching end of the lower part using a snap-fit mechanism or any other applicable retention mechanism. It is understood that plate 195 may be held in place using any other suitable method known in the art, including tabs, screws, adhesives, and clips. The plate may be rotatably or hingedly attached so that the upward-facing surface of the plate may engage the downward-facing surface of an object haying a plurality of different shapes or sizes. The plate is rotatably or pivotally attached proximate to a terminating end of the lower clamping portion, wherein the plate allows the clamping element to clamp onto a greater number of objects than without the plate. Plate 195 may be comprised of non-marring materials such as plastic, silicone, neoprene, nitrile, urethanes, or any other suitable material. In one embodiment, attaching element 101 may comprise a locking mechanism associated with the torsion spring 135 and hinging mechanism 140 configured to support a locked configuration when the planar surface is tightly wedged between upper clamping portion 125 and lower clamping portion 130 allowing for firm retention, and an unlocked configuration allowing for lower clamping portion 130 to pivotally rotate respective to the torsion spring 135 and hinging mechanism 140.

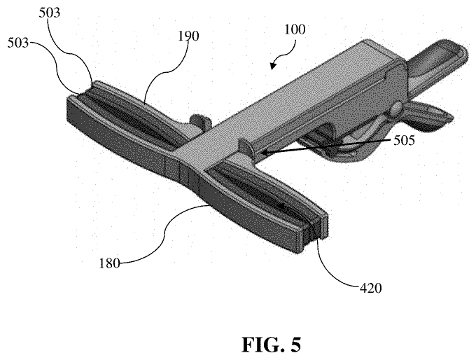

In one embodiment, apparatus 100 further comprises a retaining element 103 configured to be attached to attaching element 101 and positioned on top of an upward-facing surface of the planar surface. In the present embodiment, the retaining element 103 is on top of the upward-facing surface of the planar surface. However, it should be appreciated that the retaining element can be configured to be positioned on any surface of the planar surface that allows for efficient retention of items by the apparatus without allowing contents within items to spill such as retaining element 103 abutting with the planar surface, and such variations are within the spirit and scope of the claimed invention. Retaining element 103 comprises an elongated body 150 configured to extend across the planar surface when the device is attached to the planar surface, and a channel 160 disposed longitudinally along at least one side of the elongated body 150. In the present embodiment, the channel 160 is sized and shaped according to the outer diameter of the elongated body 150. It should be appreciated that channel 160 can have other shapes and sizes, and such variations are within the spirit and scope of the claimed invention. In one embodiment, retaining element 103 further comprises an elongated body biasing element 170 allocated within elongated body 150, a stationary arm 180, a movable arm 190, an open configuration as illustrated in FIGS. 1, 3, and 4, and a closed or substantially closed configuration as illustrated in FIGS. 2 and 5. The retaining element is configured to move between a gripping configuration and a non-gripping configuration (as further explained below).

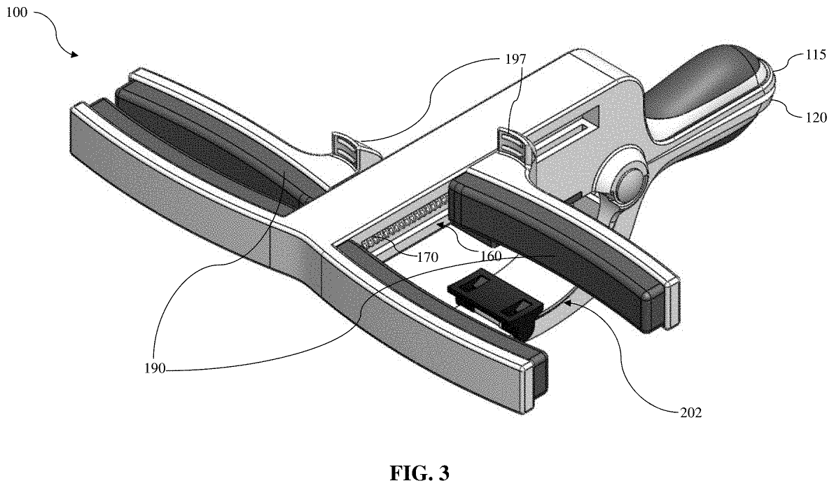

In one embodiment, the stationary arm is an elongated type element at one end of the elongated body of the retaining element. In one embodiment, torsion swing 135 allows upper clamping portion 125 and lower clamping portion 130 to continually bias towards each other in a substantially closed position wherein a surface of the planar surface is securely wedged between upper clamping portion 125 and lower clamping portion 130. In one embodiment, biasing element 170 may be disposed within elongated body 150. In one embodiment, upper clamping portion 125 and lower clamping portion 130 are significantly closer to each other in the substantially closed position than when upper clamping portion 125 and lower clamping portion 130 are in the open configuration (as illustrated in FIG. 1). In one embodiment, when apparatus 100 is actively engaged with the planar surface, retaining element 103 may switch between a closed or pipping configuration (fully closed of gripping configuration is illustrated in FIG. 2) wherein apparatus 100 is attached to the upward-facing side of the object being retained via entrapment between stationary arm 180 and movable arm 190, and the substantially open or non-gripping configuration (non-gripping configuration is illustrated in FIG. 3) wherein stationary arm 180 and movable arm 190 are not substantially in contact with each other due to no item being placed in between them. In other words, when in the gripping configuration, the moving arm is closer to the stationary arm than in the non-gripping configuration. In one embodiment, apparatus 100 may entrap an item between stationary arm 180 and movable arm 190 without upper clamping portion 125 and lower clamping portion 130 interacting with a planar surface altogether. In one embodiment, biasing element 170 is an extension spring, leaf spring, compression spring, torsion spring, magnet or any other applicable mechanism configured to provide a force to continually move the movable arm in the direction of line C or such that the movable arm continually biases toward the stationary arm. In one embodiment, biasing element 170 generates a second biasing force (as illustrated by line C) such that there is a constant force in the direction of line C forcing movable arm 190 in the direction of stationary arm 180, wherein the second biasing force is sufficient to maintain an item or container between movable arm 190 and stationary arm 180. The second biasing force may provide the constant rotation regardless of an item being present between the stationary arm 180 and the movable arm 190 allowing a user force applied via flange 197 to prevent movable arm 190 from touching stationary arm 180. In other words, the second biasing force as described herein allows moving arm 190 to continuously move in a manner toward stationary arm 180 in the direction of line C in order to render a gripping or open configuration in which the combination of the biasing force and retention space defined by stationary arm 180 and the movable arm 190 securely retains an item between the stationary arm 180 and the movable arm 190. The biasing force may be overcome by an opposing force (as illustrated by line D) applied by the user in order to allow the size of the retention space generated by stationary arm 180 and the movable arm 190 to be adjusted based on the size, shape, and/or dimension of the item being retained. In one embodiment, stationary arm 180 and moveable arm 190 may comprise a cushioning interior configured to prevent damage to the item or container being retained between stationary arm 180 and moveable arm 190. The cushioning interior may include but is not limited to, ornamental material, wool, hair, feathers, polyester staple fiber, non-woven material, paper, foam, or any other applicable material configured to serve as a cushion or protective material.

Referring now to FIG. 2, apparatus 100 depicts the substantially closed configuration wherein handle end 120 is fully engaged allowing lower clamping portion 130 and plate 195 to be in direct contact with the planar surface due to the user-applied force (which may be illustrated in the direction of lines A) that is greater than the first biasing force causes the lower clamping 130 to move toward (in the direction of line B) the downward-facing surface of planar surface 405 so that the attaching element attaches the attaching element to the object, and the distance between handle end 115 and handle end 120 is maintained by torsion spring 135. Movable arm 190 is directly in contact with stationary arm 180 due to the second biasing force (as illustrated by line C) not being subject to the contrasting force (as illustrated by line D) which would otherwise be present if the user applied the contrasting force manually or an item was positioned in between stationary arm 180 and moveable arm 190 generating the retention space. In one embodiment, retaining element 103 may further comprise one or more flanges 197 configured to traverse elongated body 150 and/or channel 160 in the direction of the biasing force (as illustrated by line C) upon interaction with the user or in the direction of the contrasting force (as illustrated by line D) when the user wants to insert an item between stationary arm 180 and moveable arm 190. In one embodiment, when stationary arm 180 and moveable arm 190 are not in complete contact with each other, then a retention space 202 is generated. Flange 197 is configured to decrease or increase the size of retention space 202 subject to whether flange 197 is moved in the direction of the second biasing force or flange 197 is moved in the direction of the contrasting force. In one embodiment, the user may adjust flange 197 to alter the necessary retention space 202 associated with the respective item to be housed in retention space 202. The substantially closed or gripping configuration as illustrated in FIG. 2 provides a configuration wherein apparatus 100 may be affixed to the planar surface via the clamping of handle end 120, lower clamping portion 130, and plate 195 to the downward-facing surface of planar surface while at the same time stationary arm 180 and moveable arm 190 are not being used to retain an item thus resulting in a relatively small retention space 202. In other words, the substantially closed or gripping configuration as illustrated in FIG. 2 may be caused by items formerly retained in the retention space being safely and securely delivered to the applicable destination and the user not wishing to detach apparatus 100 from the planar surface; thus, the second biasing force progressively returning movable arm 190 into direct contact with stationary arm 180.

Referring now to FIG. 3, apparatus 100 depicts the open configuration wherein upper clamping portion 125 and lower clamping portion 130 are further away from each other than when in the closed configuration and handle end 115 and handle end 120 are closer to each other than when in the closed configuration (illustrated in FIG. 2). In one embodiment, the user must apply a squeezing force (in the direction of either arrowed line A) to handle end 115 and/or handle end 120 greater than the first biasing force produced by torsion spring 135 in order to allow clamping portion 125 and clamping portion 130 to separate from each other. For example, once the user applies the squeezing force to handle end 115 and/or handle end 120, then handle end 115 and handle end 120 may move toward each other and simultaneously or subsequently cause clamping portions to separate from each other.

In one embodiment, apparatus 100 may comprise a plurality of stationary arms 180 and moveable arms 190, and flange 197 may be a plurality of flanges operating on separate sides of apparatus 100 separated by elongated body 150 further comprising distinct channels 160 and biasing elements 170 allocated respectively as illustrated in FIG. 3. Moveable arms 190 may translate longitudinally along respective sides of elongated body 150 via channels 160. Flanges 197 may traverse opposing sides of elongated body 150 via channels 160, allowing the user to adjust the size of retention space 202 respective to the independently adjustable movable arms 190 based on the size of the item that is being retained in retention space 202.

Referring now to FIG. 4, apparatus 100 depicts two variations of the open configuration in which handle end 115 and handle end 120 are separated from each other resulting in upper clamping portion 125 contacting an upward facing surface of a planar surface 405 and lower clamping portion 130 contacting a downward-facing surface of the planar surface 405 firmly and securely attaching apparatus 100 to a side of the planar surface 405, and allowing elongated body 150 to extend along planar surface 405. In the present embodiment, planar surface 405 is a table, tray, or any other applicable attachable surface. However, it should be appreciated that planar surface 405 may be any type of surface configured to support attachments such as, but not limited to, adhesives, magnets, and such variations within the spirit and scope of the claimed invention.

In application, apparatus 100 is configured to retain a martini or cocktail glass 410 within a first retention space 420 specifically adjusted by the user in order to firmly and securely retain and compress the stemmed component of cocktail glass 410 so as to prevent content within cocktail glass 410 from spilling or overflowing. Simultaneously, apparatus 100 is configured to retain a highball glass 415 within a second retention space 425 which has been specifically adjusted by the user to account for the greater width of the highball glass 415 compared to cocktail glass 410 in order to prevent content within highball glass 415 from spilling or overflowing. In one embodiment, the horizontal lengths of stationary arm 180, movable arm 190, and/or maybe extended or shortened in order to account for various sizes and widths of items being placed in the retention space. For both first retention space 420 and second retention space 425, both moveable arms 190 have been adjusted and positioned at desirable locations at channels 160 by the user applying the contrasting force on flanges 197 which must be greater than the second biasing force provided by biasing element 170 which forces movable arms 190 to continuously move towards stationary arms 180 until first retention space 420 and second retention space 425 are filled with an item or stationary arms 180 and movable arms 190 are in direct contact due to the lack of item to fill the retention space. In one embodiment, an item to fill the retention space may be glassware, plasticware, a cup, glass, a stemmed glass, a highball glass, a rocks glass, a snifter, a martini glass, a wine glass, etc., or any combination thereof.

Referring now to FIG. 5, apparatus 100 is presented in a closed configuration in which either an item comprising a narrow width, such as cocktail glass 410, may fill retention space 420 as illustrated in FIG. 4 or no item is present altogether and stationary arm 180 is in direct contact with movable arm 190 due to the second biasing force continuously pushing movable arm 190 towards stationary arm 180 and there being nothing to separate the two besides a small amount of retention space 202 caused by the cushioning interior of stationary arm 180 and movable arm 190. In one embodiment, at least one of stationary arm 180, movable arm 190, and/or both further comprises inward facing portions comprising one or more gripping elements 503 configured to facilitate maintaining an item or container held between stationary arm 180 and movable arm 190. In one embodiment, gripping elements 503 may comprise foam, polymer, wood, steel, metal, or any other applicable material. In one embodiment, gripping elements 503 may generate one or more interlocking connections which may be accomplished by one or more adhesive or bonding mechanisms, such as but not limited to, synthetic polymers, VELCRO®, lock strips, hook and loop fasteners, or any other applicable material configured to securely retain an item from two opposing sides in a manner that prevents content within the item from being released. In one embodiment, a cover 505 may be used to secure biasing element 170 within the elongated body 150. Cover 505 seeks to prevent the user from damaging biasing element 170 or pinching their hand and/or fingers by placing them near channel 160. Cover 505 may be composed of plastic, steel, metal, silicone, neoprene, nitrile, urethanes, or any other suitable material. However, it is understood that other means for maintaining the spring within the elongated shaped body may be used and are within the spirit and scope of the present invention.

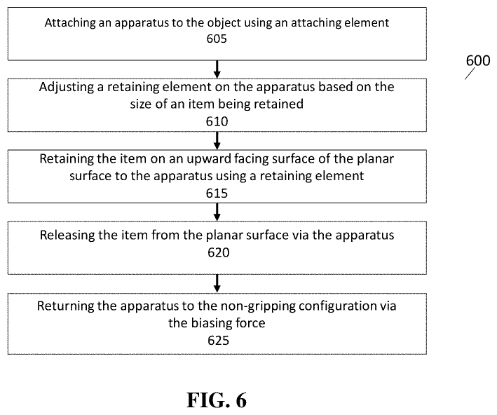

Referring now to FIG. 6, is a block diagram depicting a method 600 for utilizing apparatus 100 for securing a container to a planar surface. The hereinafter disclosed steps need not be performed in any particular order. At step 605, apparatus 100 is attached to planar surface 405 by placing a side of planar surface 405 in between upper clamping 125 and lower clamping portion 130. In application, once upper clamping portion 125 efficiently extends over an upward facing surface of planar surface 405, then the user may remove the squeezing or opening force (which may be illustrated in the direction of lines A) so that the first biasing force causes the lower clamping 130 to move toward (in the direction of line B) the downward-facing surface of planar surface 405 so that the attaching element attaches the attaching element to the object. Planar surface 405 is considered securely affixed to once plate 195 is in direct contact with a downward-facing surface of planar surface 405. The attaching element essentially clamps or attaches the apparatus to the object.

Once the clamping, clasping, or gripping force securely retains placement of apparatus 100 on planar surface 405, step 610 occurs in which upper part 105 and lower part 110 are continually biasing toward each other in an attempt to achieve a closed or substantially closed position wherein upper part 105 and lower part 110 are in direct physical contact. Simultaneously, movable arm 190 is proximate to stationary arm 180 due to biasing element 170 generating the second biasing force (as illustrated by line C), which is the result of an item not being present in retention space 420 as shown in FIG. 5. At step 615, the user places an item in retention space 420 by applying the contrasting force (as illustrated by line D) to flanges 197, resulting in movable arm 190 being separated from stationary arm 180 via translating longitudinally along elongated body 150 via channel 160. The user does not need to separate movable arm 190 the maximum distance apart possible from stationary arm 180 due to the second biasing force making movable arm 190 move in a rotational manner toward stationary arm 180. The user must apply the contrasting force with at least a greater pressure than the pressure associated with the second biasing force to the point where retention space 420 is long and/or wide enough to fit the item being retained by retaining element 103. Once retention space 420 is adequately occupied by the item or container, the second biasing force will force movable arm 190 to come into contact with the item resulting in apparatus 100 moving into the gripping configuration wherein gripping elements 503 disposed on stationary arm 180, and movable arm 190 cooperate to securely retain the item or container in a manner that prevents spilling of contents within the item or container. For example, when in the gripping configuration, highball glass 415 is able to stand upright within retention space 420 via the base of highball glass 415 being supported by planar surface 405, the structure of highball glass 415 being supported by stationary arm 180 and applicable gripping elements 503, and the second biasing force applying a constant retention pressure via movable arm 190 along with the applicable gripping mechanisms. At step 620, once the item or container reaches a location desired by the user, the user may remove the item or container from retention space 420. In one embodiment, the item or container is removed by the user applying, via flange 197, the contrasting force in the direction of line D at a pressure greater than the second biasing force; thus making retaining element 103 loosen the retentive grip on the item or container and making the item or container ready for easy removal by the user. At step 625, once the item or container is removed from retention space 420, then the second biasing force moves movable arm 190 towards stationary arm 180 until the movable arm 190, and stationary arm 180 are in direct contact resulting in apparatus 100 entering gripping configuration as illustrated in FIG. 5.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. An apparatus for securing a container to n object, wherein the apparatus comprises:
a clamping element configured to removably attach the apparatus to the object; at least one retaining element connected to the clamping element and configured to be positioned on top of an upward-facing surface of the object, wherein the at least one retaining element is configured to move between a gripping configuration and a non-gripping configuration, and wherein in the gripping configuration, each retaining element holds the container on the object when the apparatus is attached to the upward-facing side of the object.

2. The apparatus of claim 1, wherein the clamping element comprises:
an upper part having an upper handle portion and an upper clamping portion;
a lower part having a lower handle portion and a lower clamping portion;
a biasing element rotatably engaging the upper part with the lower part;
the biasing element providing a biasing force for continually biasing the upper clamping portion and lower clamping portion toward each other towards a closed position.

3. The apparatus of claim 2, wherein in the closed position the upper clamping portion and lower clamping portion are closer to each other than when in an open configuration;
wherein the upper handle portion and lower handle portion are further away from each other in the closed configuration than when in the open configuration; and,
wherein applying a squeezing force to at least one of the upper handle portion and lower handle portion greater than the biasing force causes the lower clamping portion and upper clamping portion to separate.

4. The apparatus of claim 1, wherein the retaining element comprises an elongated body configured to be positioned on the upward-facing side of the object when the apparatus is attached to the object;
at least one channel disposed longitudinally along at least a first side of the elongated body;
an elongated body biasing element within the elongated body;
a stationary arm at one end of the elongated body;
a movable arm configured to translate longitudinally along at least a first side of the elongated body;
wherein the elongated body biasing element provides a second biasing force so that the moving arm continuously moves toward the stationary arm and into the gripping configuration; and,
wherein in the gripping configuration, the moving arm is closer to the stationary arm than in the non-gripping configuration.

5. The apparatus of claim 4, wherein the elongated body biasing elements a compression spring.

6. The apparatus of claim 5, wherein in the gripping configuration the second biasing force provided by the elongated body biasing element is sufficient to maintain a container between the moving arm and the stationary arm.

7. The apparatus of claim 4, wherein the inward-facing portions of at least one of the stationary arm and the moving arm having a gripping element configured to facilitate maintaining the container held between the stationary arm and the moving arm.

8. The apparatus of claim 7, wherein the gripping element comprises at least one of foam, polymer, wood, steel, metal, and any combination thereof.

9. The apparatus of claim 1, wherein the container comprises glassware, a cup, glass, a stemmed glass, a highball glass, a rocks glass, a snifter, a martini glass, a wine glass, etc. or any combination thereof.

10. The apparatus of claim I, wherein the object s a table or tray.

11. The apparatus of claim 2, wherein a plate is rotatably attached proximate a terminating end the lower clamping portion, wherein the plate allows the clamping element o clamp onto a greater number of objects than without the plate.

12. An apparatus for securing an item to an object, wherein the apparatus comprises:
an attaching element configured to removably attach the apparatus to the object; at least one retaining element connected to the attaching element and configured to be positioned on top of an upward-facing surface of the object, wherein the at least one retaining element is configured to move between a gripping configuration and a non-gripping configuration, and wherein in the gripping configuration each retaining element holds the item on the upward-facing surface of the object when the apparatus is attached to the object.

13. The apparatus of claim 12, wherein the retaining element comprises
an elongated body;
at least one channel disposed longitudinally along at least a first side of the elongated body;
an elongated body biasing element within the elongated body;
a stationary arm at one end of the elongated body;
a movable arm configured to translate longitudinally along at least a first side of the elongated body;
wherein the elongated body biasing element provides a biasing force so that the moving arm continuously moves toward the stationary arm and into the gripping configuration; and,
wherein in the gripping configuration the moving arm is closer to the stationary arm than in the non-gripping configuration so that the item is not held by the retaining element.

14. The apparatus of claim 13, wherein in the gripping configuration the biasing force provided by the elongated body biasing element is sufficient to maintain a container between the moving arm and the stationary arm.

15. The apparatus of claim 13, wherein the inward-facing portions of at least one of the stationary arm and the moving arm having a gripping element configured to facilitate maintaining the item held between the stationary arm and the moving arm.

16. The apparatus of claim 12, wherein the item comprises at least one of a tableware, flatware, food item, glassware, a cup, glass, a stemmed glass, a highball glass, a rocks glass, a snifter, a martini glass, a wine glass and any combination thereof.

17. The apparatus of claim 12, wherein the object is a table or tray.

18. A method of securing an item to an object comprising, wherein the method comprises:
attaching an apparatus to the object using an attaching element; and,
retaining the item on an upward facing surface of the planar via to the apparatus using a retaining element.

19. The method of claim 18, wherein the attaching element clamps the apparatus on the object.

20. The method of claim 18, wherein the retaining element uses a biasing force to secure the item to the apparatus.
